(19) United States
(12) Patent Application Publication
(10) Pub. No.: US 2022/0309577 A1
(43) Pub. Date: Sep. 29, 2022

(54) AUDIO-ENABLED TRADING MARKET MONITORING SYSTEM

(71) Applicant: Andres Aquero, Miami, FL (US)

(72) Inventor: Andres Aquero, Miami, FL (US)

(21) Appl. No.: 17/212,909

(22) Filed: Mar. 25, 2021

(51) Int. Cl. G06Q 40/04; G06F 3/16; G06F 16/638

(52) U.S. Cl. CPC G06Q 40/04; G06F 3/167; G06F 16/639

(57) ABSTRACT

An audio-enabled market monitoring system is disclosed, including a device in operable connection with a network. An application server is in operable communication with the network to host an application system displaying security information. The application system includes a user interface module for providing access to the application system to the at least one device. The user interface is in operable communication with a security database to receive security information from a third-party. The user interface module displays a playlist interface to display selected securities and to permit the selection of an audio button to transmit audio updated related to the selected security.

### TECHNICAL FIELD

The embodiments generally relate to computerized systems for market monitoring and more particularly to computerized systems for the audible conveyance of trading market information to users.

### BACKGROUND

Market monitoring, especially when performed in real-time, can involve the consumption of large amounts of ever-changing data. One way markets information is consumed is via text provided on the display of a computing device. This information includes a ticker symbol (usually 1 to 4 letters that represent the entity associated with a security), a price, a price change, and volume. Tickers may also be used to indicate pricing changes in index funds.

In the current arts, many traders feel the need to continuously monitor markets in order to have the most up-to-date information when making trading decisions. Some users use multiple monitors or other display devices to view market information, often multi-tasking while doing so. Monitoring markets can be difficult when away from a computing device, when driving, or when performing other activities, causing an inconvenience to traders. While text-to-speech systems exist, these systems are often not sufficient for monitoring stock information in real-time. In such, using these systems may leave the trader unsure if the information they are receiving is accurate.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments provided herein relate to an audio-enabled market monitoring system, including a device in operable connection with a network. An application server is in operable communication with the network to host an application system displaying security information. The application system includes a user interface module for providing access to the application system to the at least one device. The user interface is in operable communication with a security database to receive security information from a third-party. The user interface module displays a playlist interface to display selected securities and to permit the selection of an audio button to transmit audio updated related to the selected security.

The audio-enabled trading market monitoring system allows a user to monitor securities by receiving audio communications from their computing device. The system will allow the user to receive audible updates when they may be unable to view trading charts (e.g., while driving). The system will allow the user to configure notification settings, such as selecting a time interval or price interval in which they will receive the notifications of updates for each security they have selected. The system will also allow for voice input by the user, such as to request the ask or bid price of a specific security.

In one aspect, a security interpretation module interprets the security information.

In one aspect, the broadcast module broadcasts the interpreted security information received from the security interpretation module.

In one aspect, a notification settings interface is operable via the user interface module. The notification settings module permits the user to select a time interval to receive audio updates related to the security.

In one aspect, the notification settings module permits the user to select for the system to announce an ask price or a bid price.

In one aspect, the security database stores security information including a price, a price change, and a trade volume.

In one aspect, the device includes a microphone to receive audio communications from a user.

In one aspect, the device includes one or more speakers to emit audio related to the audio updates of the security.

In one aspect, a playlist generator permits the user to select the security and add the security to the playlist interface.

A method for providing an audio-enabled market monitor is disclosed. The method includes the steps of searching, via a device in communication with a search engine and user interface module, one or more securities. A playlist indicator is selected which corresponding to the one or more securities to add the one or more securities to a playlist interface. The user then selects an audio button to initiate, via a broadcast module, audio updated broadcasted via a speaker in communication with the device.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of the network infrastructure, according to some embodiments;

FIG. 2 illustrates a block diagram of the application system, according to some embodiments;

FIG. 3 illustrates a flowchart of a process for creating a playlist for one or more securities, wherein the playlist provides selective audio monitoring for each security, according to some embodiments;

FIG. 4 illustrates a screenshot of the playlist interface including a plurality of securities and the audio-enablement button to provide audio monitoring of the securities, according to some embodiments;

FIG. 5 illustrates a screenshot of the notification settings interface, according to some embodiments;

FIG. 6 illustrates a block diagram of the server engine and modules, according to some embodiments; and

FIG. 7 illustrates a flowchart of a method for broadcasting security information, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood thereon.

Before describing in detail exemplary embodiments, it is noted that the embodiments reside primarily in combinations of components and procedures related to the system. Accordingly, the system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to an audio-enabled trading market monitoring system which allows a user to monitor stocks by receiving audio communications from their computing device. The system will allow the user to receive audible updates when they may be unable to view trading charts (e.g., while driving). The system will allow the user to configure notification settings, such as selecting a time interval or price interval in which they will receive the notifications of updates for each security they have selected. The system will also allow for voice input by the user, such as to request the ask or bid price of a specific security.

As used herein, the term “security” relates to any tradable financial asset or any form of financial instrument. This may include debt securities (banknotes, bonds, and debentures), equity securities (common stocks), and derivatives (forwards, futures, options, and swaps). Further, the term “security” may extend to cryptocurrencies and Forex exchanges. In such, the user may ask for the bid and/or ask of a security, and/or the bid and/or ask for a Forex or cryptocurrency to aid in the monitoring thereof.

As used herein, the term “security information” may relate to any information related to the security such as the ask and/or bid price, price change, trade volume, etc. Further the security information may include general information including daily trends, security summaries, company information (such as information related to a publicly traded company which the user has added to their playlist).

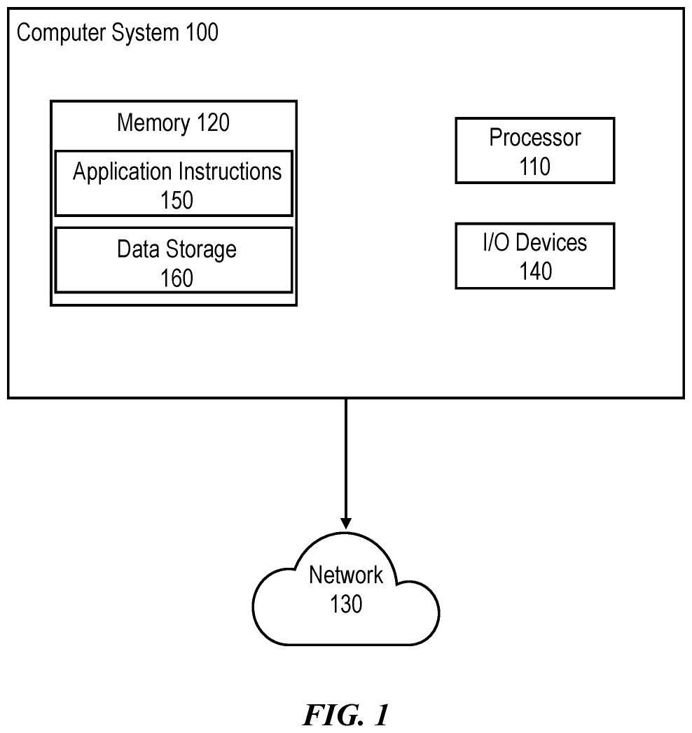

FIG. 1 illustrates a computer system 100, which may be utilized to execute the processes described herein. The computer system 100 is comprised of a standalone computer or mobile computing device, a mainframe computer system, a workstation, a network computer, a desktop computer, a laptop, or the like. The computer system 100 includes one or more processors 110 coupled to a memory 120 via an input/output (I/O) interface. Computer system 100 may further include a network interface to communicate with the network 130. One or more input/output (I/O) devices 140, such as video device(s) (e.g., a camera), audio device(s), and display(s) are in operable communication with the computer system 100. In some embodiments, similar I/O devices 140 may be separate from computer system 100 and may interact with one or more nodes of the computer system 100 through a wired or wireless connection, such as over a network interface.

Processors 110 suitable for the execution of a computer program include both general and special purpose microprocessors and any one or more processors of any digital computing device. The processor 110 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 100 and other devices attached to a network 130, such as other computer systems, or between nodes of the computer system 100. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol.

The memory 120 may include application instructions 150, configured to implement certain embodiments described herein, and a database 160, comprising various data accessible by the application instructions 150. In one embodiment, the application instructions 150 may include software elements corresponding to one or more of the various embodiments described herein. For example, application instructions 150 may be implemented in various embodiments using any desired programming language, scripting language, or combination of programming languages and/or scripting languages (e.g., C, C++, C#, JAVA®, JAVASCRIPT®, PERL®, etc.).

The steps and actions of the computer system 100 described in connection with the embodiments disclosed herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

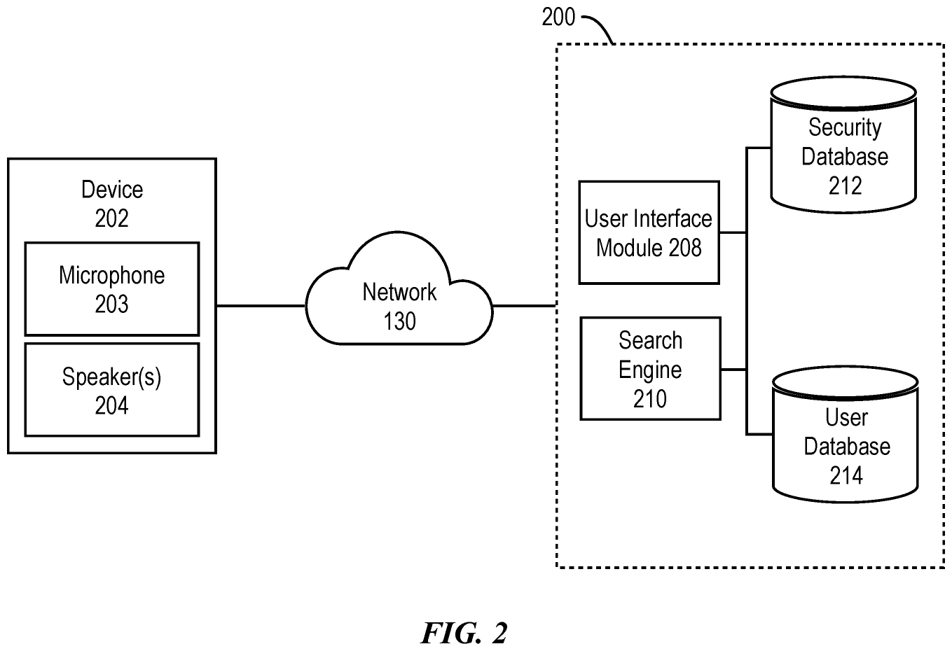

FIG. 2 illustrates a block diagram of the application system 200 in operable communication with a device 202 via a network 130. The device is in operable communication with a microphone 203 to receive audio input from the user. Alternatively, the user may use the user interface provided on the display of the device 202. A speaker 204 emits audio related to the security information or other information related to the system. The application system 200 includes a user interface module 208 operable to display the security information and permit the user to select the audio button associated with one or more securities. The user interface module 208 also displays user preferences, including audio notification preferences as described herein. The search engine 210 permits the user to search the securities database 212 and/or user database 214. The securities database 212 includes security information received from a third-party information source. The user database 214 stores user preferences, notification settings, personal information and the like.

While it is preferred that the system described herein be operated on a mobile application on a smartphone, one skilled in the arts will readily understand that the system may be operable on various devices including a desktop computer, laptop computer, tablet, etc.

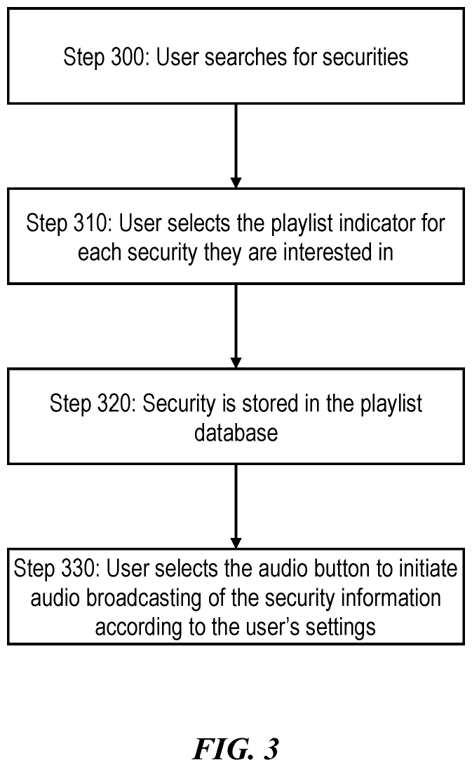

FIG. 3 illustrates a flowchart of a process for creating a playlist for one or more securities. In step 300, the user searches the securities database for securities and in step 310, the user selects one or more securities they are interested in. The user may select a playlist indicator which allows the user to add the security and associated information to their playlist. In step 320, the security is stored in the playlist database and in step 330, the user selects the audio button to initiate audio broadcasting of the security information according to the user's notification settings.

The playlist allows the user to select a plurality of securities to be stored in the playlist database and displayed, via the user interface module, on the computing device. The playlist interface provides a convenient means for the user to view security information for securities they are interested in. Once the security is displayed on the playlist, the user can select the audio button to initiate audio updates and regular time intervals selected by the user.

In some embodiments, the user may select securities which are grouped in various playlist categories based on the type of security such as debt securities (banknotes, bonds, and debentures), equity securities (common stocks), and derivatives (forwards, futures, options, and swaps).

In some embodiments, the user may select to organize securities in their playlist based on the value of the security, or by the current trend of the security (e.g., whether the security is gaining or losing value over a period of time).

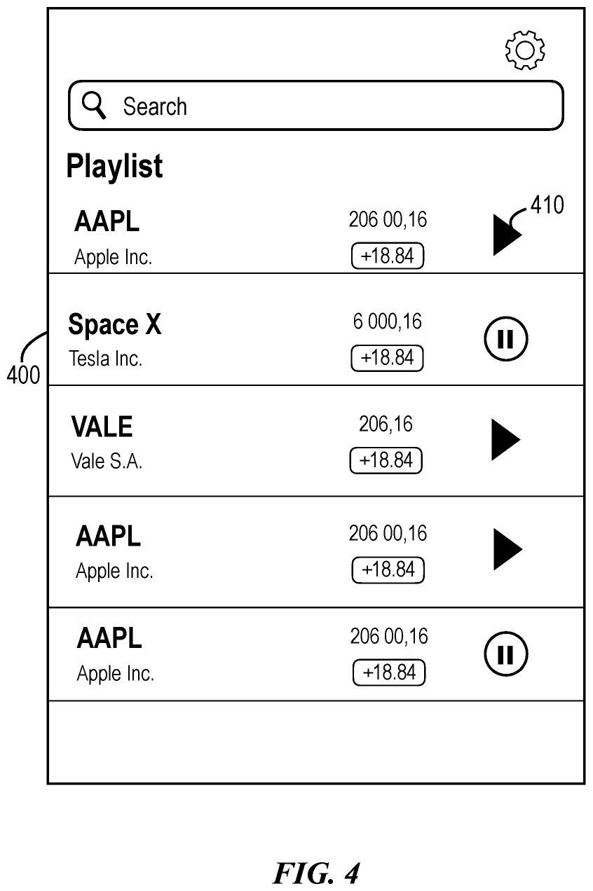

FIG. 4 illustrates a screenshot of the playlist interface 400 to display security information such as the ticker symbol, company name, price, price change, and audio button 410. The playlist is a compilation of securities which the user has searched and selected to add to their watch list as described in FIG. 3. The audio button 410 can be selected by the user to initiate the broadcasting of audio related to the security. For example, selecting the audio button 410 may initiate an audio transmission of the price 10-seconds. In such, the user can listen to audio emitted by the system for convenience such as while multitasking on their computer, while driving, or when looking at a device display screen is not possible, unsafe, or inconvenient. The playlist interface 400 may display a plurality of securities while permitting the user to select multiple audio buttons to receive notifications for each of the selected securities.

The playlist interface may be configured to cycle through the securities selected to be included on the playlist interface. For example, the user may receive broadcasted information related to each security in the listing of securities, such that that user is provided with a cycled playlist of each security's ask and/or bid price.

In some embodiments, the user may ask for the last price. This option is provided as a setting which the user may select in their settings. In such, the user may select to receive the last price, the bid, and/or the ask for a security, Forex, and/or cryptocurrency.

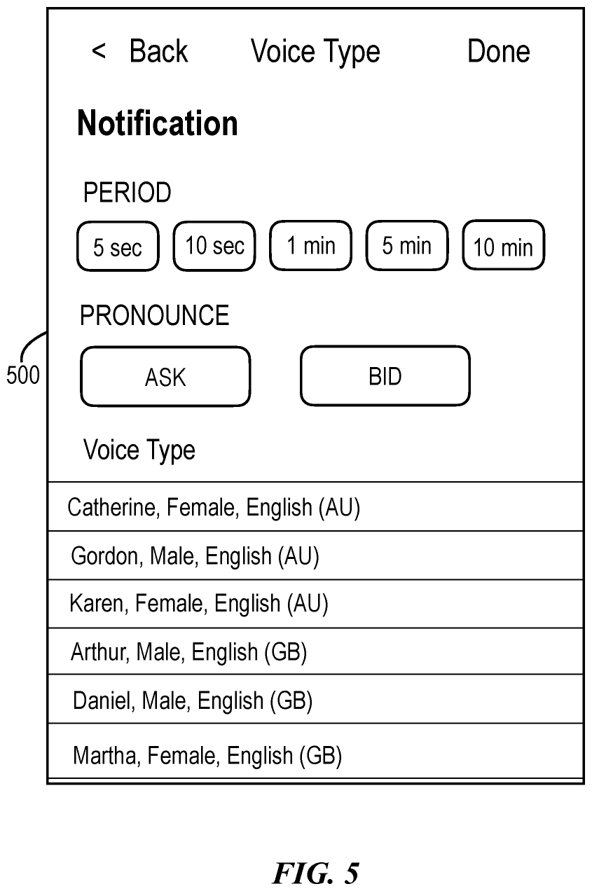

FIG. 5 illustrates a screenshot of the notification settings interface 500 wherein the user can select user preferences such as audio notification settings. The audio notification settings include a time period for each update (e.g., 5-seconds, 10-seconds, 1-minute, 5-minutes, 10-minutes, etc.). Further the user may select to receive the ask price and/or the bid price for each security. The voice of the audio notification may be selected and may be dependent on the device which the user is utilizing. The audio notification settings may be applied to a single security or a plurality of securities to allow the user to customize updates for each security. In one example, the user selects to receive ask price notifications for a security every 5-minutes. This will allow the user to receive audio updates automatically the indicated securities.

In some embodiments, the user may select maximum and minimum prices to receive updates, such that updated will start at a user-specified ask price and stop at a user-specified ask price. In such, the user will only receive updates they are interested in receiving.

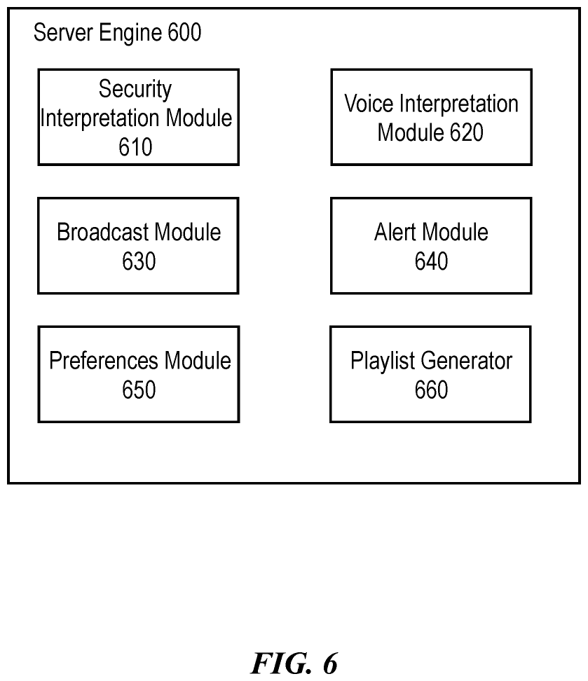

FIG. 6 illustrates a block diagram of the server engine 600 and modules including a security interpretation module 610, voice interpretation module 620, broadcast module 630, alert module 640, preferences module 650, and playlist generator 660. The security interpretation module 610 receives security information from the third-party and interprets the security information, such as the price, price change, trade volume, etc. For example, the security interpretation module 610 determines a price and transmits the price information to the broadcast module 630. The voice interpretation module 620 interprets audio input from the user, such as the user using audio control functionalities. For example, the user may say “add to playlist” resulting in the security being added to playlist. A broadcast module 630 receives user notification settings input in the notification settings interface and determines when to emit an audio sound of the security information. Further, the broadcast module 630 may determine, along with the security interpretation module 610, if a price change has occurred. For example, the user may select to receive and audio alert when the price changes by 10-cents (or another value or percentage). The alert module 640 transmits alerts to the user. The alerts may include alerts related to security information (e.g., a specific security is going up in value), general systems alerts, etc. The preferences module 650, interprets user preferences input in the notification settings interface. The playlist generator 660 generates a playlist from user-selected securities and permits the user to select the audio button to enable audio updated for the securities stored in the playlist.

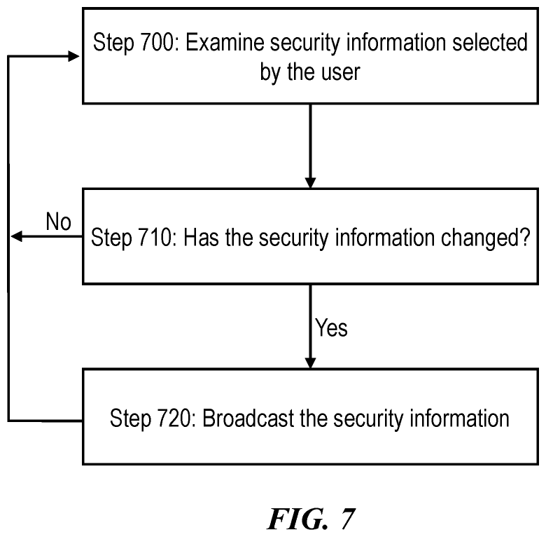

FIG. 7 illustrates a flowchart of a method for broadcasting security information according to an exemplary embodiment. In step 700, the security interpretation module examines security information selected by the user. In step 710, the security interpretation module determines if the security information has changed (e.g., has the price changed by a threshold value, etc.). If the security information has changed, the broadcast module facilitates the broadcasting of the security information via the user's device in step 720.

In some embodiments, the audio button enables the broadcasting of the ask price and/or the bid price associated with a security. The ask and/or bid price is provided at time intervals selected by the user.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way or combination, and the present specification, including the drawings, shall be construed to constitute a complete written description of all combinations and subcombinations of the embodiments described herein, and of the manner and process of making and using them, and shall support claims to any such combination or sub combination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. An audio-enabled market monitoring system, comprising:
at least one device in operable connection with a network;
an application server in operable communication with the network, the application server configured to host an application system displaying security information, the application system having a user interface module for providing access to the application system to the at least one device, the user interface in operable communication with a security database to receive security information from a third-party, the user interface comprising:
a playlist interface to display selected securities, the playlist interface to permit the selection of an audio button to transmit audio updated related to the selected security.

2. The system of claim 1, further comprising a notification settings interface operable via the user interface module.

3. The system of claim 2, wherein the notification settings module permits the user to select a time interval to receive audio updates related to the security.

4. The system of claim 3, wherein the notification settings module permits the user to select for the system to announce an ask price or a bid price.

5. The system of claim 1, wherein the security database stores security information including a price, a price change, and a trade volume.

6. The system of claim 5, wherein the device includes a microphone to receive audio communications from a user.

7. The system of claim 6, wherein the device includes one or more speakers to emit audio related to the audio updates of the security.

8. The system of claim 1, wherein a playlist generator permits the user to select the security and add the security to the playlist interface.

9. An audio-enabled market monitoring system, comprising:
at least one device in operable connection with a network;
an application server in operable communication with the network, the application server configured to host an application system displaying security information, the application system having a user interface module for providing access to the application system to the at least one device, the user interface in operable communication with a security database to receive security information from a third-party, the user interface comprising:
a playlist interface to display selected securities the playlist interface to permit the selection of an audio button operable via a broadcast module to transmit audio updated related to the selected security, the broadcast module to emit an audio update at pre-determined intervals of time.

10. The system of claim 9, further comprising a security interpretation module to interpret the security information.

11. The system of claim 10, wherein the broadcast module broadcasts the interpreted security information received from the security interpretation module.

12. The system of claim 11, further comprising a notification settings interface operable via the user interface module.

13. The system of claim 12, wherein the notification settings module permits the user to select a time interval to receive audio updates related to the security.

14. The system of claim 13, wherein the notification settings module permits the user to select for the system to announce an ask price or a bid price.

15. The system of claim 14, wherein the security database stores security information including a price, a price change, and a trade volume.

16. The system of claim 15, wherein the device includes a microphone to receive audio communications from a user.

17. The system of claim 16, wherein the device includes one or more speakers to emit audio related to the audio updates of the security.

18. The system of claim 17, wherein a playlist generator permits the user to select the security and add the security to the playlist interface.

19. A method for providing an audio-enabled market monitor, the method comprising the steps of:
searching, via a device in communication with a search engine and user interface module, one or more securities;
selecting a playlist indicator corresponding to the one or more securities to add the one or more securities to a playlist interface; and
selecting an audio button to initiate, via a broadcast module, audio updated broadcasted via a speaker in communication with the device.

20. The method of claim 20, further comprising the step of determining if security information corresponding to the securities displayed on the playlist has changed.
